(19) United States
(12) Patent Application Publication
(10) Pub. No.: US 2019/0304020 A1
(43) Pub. Date: Oct. 3, 2019

(54) Electronic System and Method For Credit-Based Investments

(71) Applicant: MASTERCARD INTERNATIONAL INCORPORATED, PURCHASE, NY (US)

(72) Inventor: Vidit Bhargava, Pune (IN)

(21) Appl. No.: 16/366,337

(22) Filed: Mar. 27, 2019

(30) Foreign Application Priority Data
Mar. 28, 2018 (SG) 10201802599R

(51) Int. Cl. G06Q 40/06; G06Q 40/02; G06Q 20/10

(52) U.S. Cl. CPC G06Q 40/06; G06Q 20/102; G06Q 40/025

(57) ABSTRACT

The present disclosure generally relates to an electronic system, a computerized method, and a non-transitory computer-readable storage medium comprising instructions for credit-based investments. The system comprises a server configured to receive details of a credit payment instrument of a consumer and associated with a credit line; identify an issuer financial institution associated with the credit payment instrument; retrieve details of financial investment products offered by financial investment institutions and predetermined between the issuer financial institution and the financial investment institutions; communicate details of the financial investment products and a set of investment options associated therewith to the consumer; receive investment details determined by the consumer; and perform an investment transaction for investing the investment amount in the financial investment portfolio based on the investment details.

### CROSS-REFERENCE TO RELATED APPLICATION

This application claims the benefit of, and priority to, Singapore Patent Application No. 10201802599R filed on Mar. 28, 2018. The entire disclosure of the above application is incorporated herein by reference.

### FIELD

The present disclosure generally relates to an electronic system and method for credit-based investments. Particularly, the present disclosure describes various embodiments of an electronic system and method for investments using a credit line of a credit payment instrument.

### BACKGROUND

This section provides background information related to the present disclosure which is not necessarily prior art.

Many consumers use various cashless modes of payment for transactions with merchants. Credit payment instruments, such as credit cards, are commonly used for cashless payments. A credit card is issued by an issuer bank to a consumer or cardholder to enable the consumer to pay for transactions based on the consumer's agreement with the issuer bank to pay back the issuer bank for the amounts paid in the transactions. The credit card has a credit line, which is availed from the issuer bank to the consumer. The consumer can borrow from the credit line to pay for transactions. The credit line has a credit limit, which is defined by the issuer bank based on a credit assessment or credit score of the consumer.

Consumers tend to exercise financial prudence when using credit cards for purchasing goods from merchants, so as not to spend beyond their financial means. For example, a consumer may have a credit card with a credit limit that is a few times of his/her monthly salary, but the consumer normally spends less than his/her monthly salary with the credit card so that he/she is able to pay back the issuer bank without incurring interest charges. Some statistics indicate that consumers typically spend only 10% to 20% of their credit limit, particularly in culturally credit conservative regions. Conservative use of credit cards may be intentional as some consumers may be trying to improve their credit scores. However, one disadvantage of utilizing significantly less than the credit limit of the credit cards is that issuer banks cannot optimally benefit from their credit cards. Moreover, consumers may face more difficulty in raising their credit limits if they do not use their credit cards sufficiently.

Some issuer banks may invite consumers, i.e., their customers, to participate in investments which may be offered by the issuer banks, such as by investing in their financial investment products. U.S. Pat. No. 5,787,404 discloses an investment fund suitable for retirement purposes. The consumer establishes an investment account with an issuer bank, and funds the investment account by making a deposit of an arbitrary amount of money into the investment account. This would require the consumer to fund the investment account with cash and the consumer may be reluctant to do so as it depletes his/her liquid assets.

Therefore, in order to address or alleviate at least one of the aforementioned problems and/or disadvantages, there is a need to provide an electronic system and method for credit-based investments in which there is at least one improved feature.

### SUMMARY

This section provides a general summary of the disclosure, and is not a comprehensive disclosure of its full scope or all of its features. Aspects and embodiments of the disclosure are set out in the accompanying claims.

According to an aspect of the present disclosure, there is an electronic system, a computerized method, and a non-transitory computer-readable storage medium comprising instructions for credit-based investments. The system comprises a server configured for performing steps of the method comprising: receiving details of a credit payment instrument of the consumer, the credit payment instrument associated with a credit line; identifying, from an issuer database, an issuer financial institution associated with the credit payment instrument; retrieving, from a financial investment database, details of one or more financial investment products offered by one or more financial investment institutions, the financial investment products predetermined between the issuer financial institution and financial investment institutions; communicating, to the consumer, details of the financial investment products and a set of investment options associated therewith; receiving investment details determined by the consumer, the investment details comprising: a financial investment portfolio comprising a selection of the financial investment products offered by a financial investment institution selected by the consumer; the investment options defined by the consumer; and a percentage value defined by the consumer for determining an investment amount from the credit line; and performing an investment transaction for investing the investment amount in the financial investment portfolio based on the investment details.

An electronic system and method for credit-based investments according to the present disclosure is thus disclosed herein. Various features, aspects, and advantages of the present disclosure will become more apparent from the following detailed description of the embodiments of the present disclosure, by way of non-limiting examples only, along with the accompanying drawings.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an electronic system for credit-based investments, in accordance with embodiments of the present disclosure.

FIG. 2 is a flowchart illustration of a computerized method for credit-based investments, in accordance with embodiments of the present disclosure.

FIG. 3A and FIG. 3B are another flowchart illustration of a computerized method for credit-based investments, in accordance with embodiments of the present disclosure.

FIG. 4 is a block diagram illustration of the technical architecture of the server, in accordance with embodiments of the present disclosure.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “I” in a figure or associated text is understood to mean “and/or” unless otherwise indicated. For purposes of brevity and clarity, descriptions of embodiments of the present disclosure are directed to an electronic system and method for credit-based investments, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e., a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

### Overview

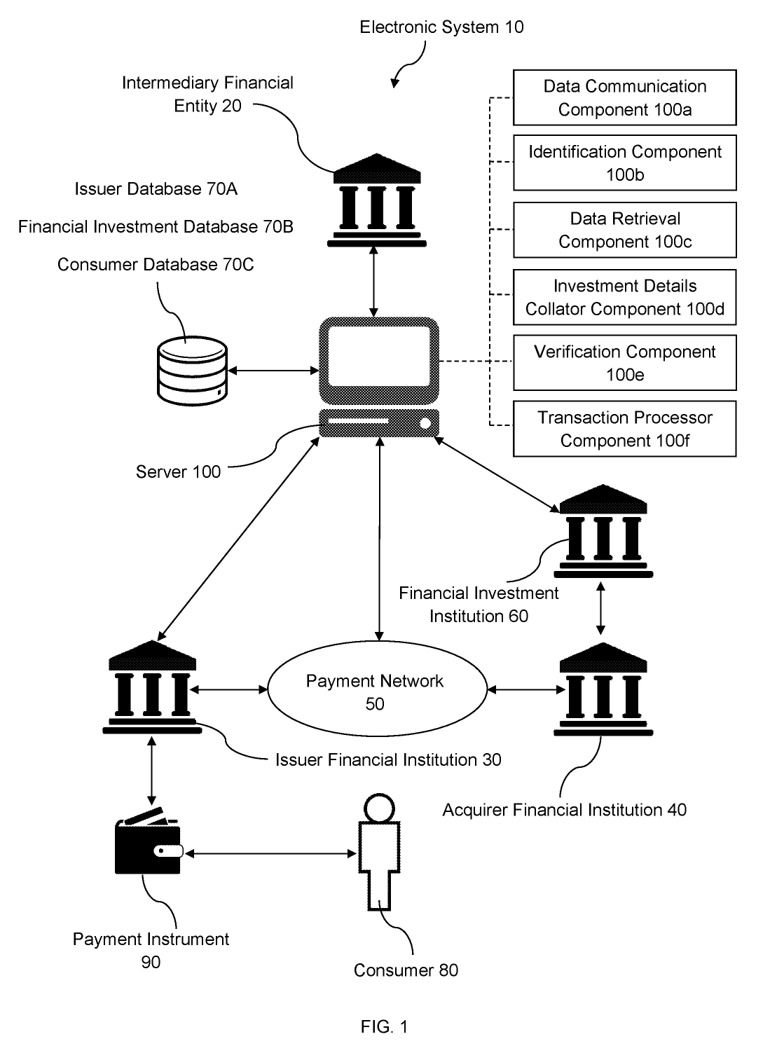

In representative or exemplary embodiments of the present disclosure, there is an electronic system 10 for credit-based investments, as illustrated in FIG. 1. The system 10 includes an intermediary financial entity 20, one or more issuer financial institutions 30, and one or more acquirer financial institutions 40. The system 10 further includes a server 100 operated by the intermediary financial entity 20. The system 10 further includes a payment network 50 communicatively connecting or linking the intermediary financial entity 20, issuer financial institutions 30, and acquirer financial institutions 40 to one another. Particularly, each of the issuer financial institutions 30 and acquirer financial institutions 40 operates its own computer processors/servers that are communicatively linked to the server 100 via the payment network 50. The payment network 50 may be operated by a payment network operator, such as Mastercard® or Visa®.

The system 10 includes one or more financial investment institutions 60 that offer financial investment products, such as fixed deposits and debentures. Each financial investment institution 60 has a financial account with an acquirer financial institution 40 in order to accept electronic payments for investing in the financial investment products. The system 10 includes an issuer database 70A containing details of issuer financial institutions 30 that have registered or enrolled with the intermediary financial entity 20 for credit-based investments. The system 10 includes a financial investment database 70B containing details of financial investment institutions 60 that have registered or enrolled with the intermediary financial entity 20 for credit-based investments. The system 10 includes a consumer database 70C containing details of consumers 80 that have registered or enrolled with the intermediary financial entity 20 for credit-based investments.

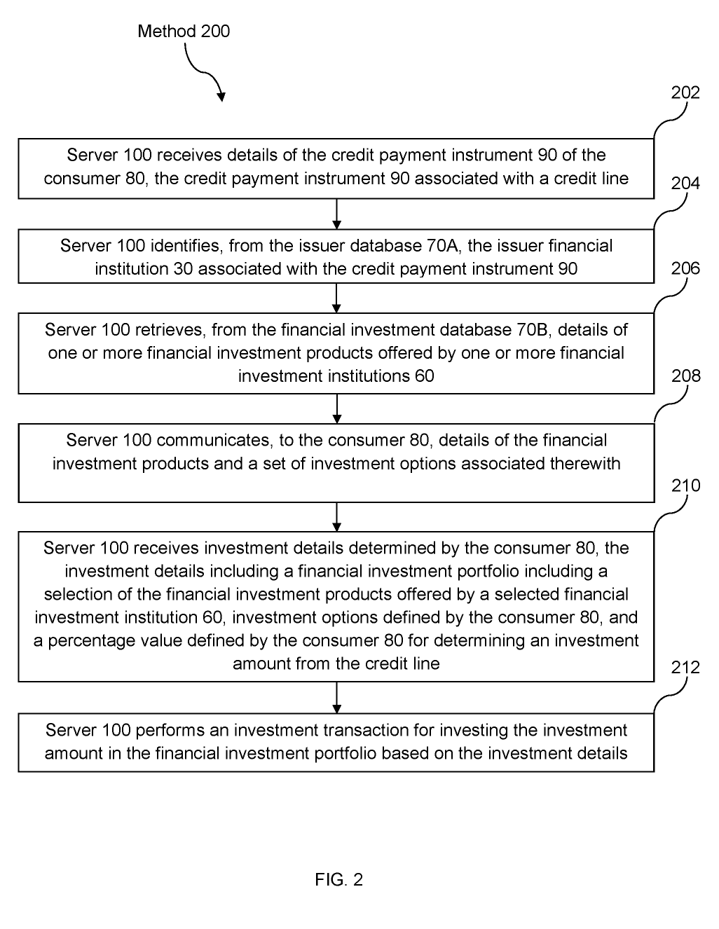

Further with reference to FIG. 2, there is shown a computer-implemented or computerized method 200 implemented on the server 100. An application is hosted on the server 100 to perform the method 200. The application provides a user interface accessible by the issuer financial institutions 30 and financial investment institutions 60, as well as consumers/users 80 who intend to invest in the financial investment products using credit payment instruments 90, such as a credit card. Notably, a credit payment instrument 90 is issued to a consumer 80 by an issuer financial institution 30. The consumer 80 may access the user interface with an electronic device such as a computer or mobile phone.

In a step 202 of the method 200, the server 100 receives details of the credit payment instrument 90 of the consumer 80, the credit payment instrument 90 associated with a credit line. The credit line is availed to the consumer 80 by the issuer financial institution 30 and is capped at a credit limit. In a step 204, the server 100 identifies, from the issuer database 70A, the issuer financial institution 30 associated with, i.e., that has issued, the credit payment instrument 90. In a step 206, the server 100 retrieves, from the financial investment database 70B, details of one or more financial investment products offered by one or more financial investment institutions 60. The financial investment products have been predetermined between the issuer financial institution 30 and financial investment institutions 60. Particularly, the issuer financial institution 30 has selected, from among all the financial investment products offered by all the financial investment institutions 60, the financial investment products that the issuer financial institution 30 considers to be most beneficial to themselves and the consumers 80.

In a step 208, the server 100 communicates, to the consumer 80, details of the financial investment products and a set of investment options associated therewith. The consumer 80 may receive the details and investment options on his/her electronic device. The investment options may relate to risk options of the financial investment products, allowing the consumer 80 to select his/her preferred financial investment products based on his/her risk appetite. In a step 210, the server 100 receives, e.g., from the consumer electronic device, investment details determined by the consumer 80. The investment details include a financial investment portfolio including a selection of the financial investment products offered by a selected financial investment institution 60, investment options defined by the consumer 80, and a percentage value defined by the consumer 80 for determining an investment amount from the credit line. For example, the consumer 80 may input a percentage value of 20% and if the credit line availed to the consumer 80 is $10,000 (i.e., capped at the credit limit of $10,000), then the investment amount is $2,000. The details provided by the consumer 80 may be stored on the consumer database 70C. In a step 212, the server 100 performs an investment transaction for investing the investment amount in the financial investment portfolio based on the investment details.

The system 10 and method 200 thus allow the consumer 80 to use the credit line of the credit payment instrument 90 to invest in various financial investment products which the consumer 80. For the consumer 80, he/she does not need to utilize his/her liquid assets, e.g., cash, for investments, thereby freeing up the liquid assets for other purposes. The consumer 80 also utilizes a larger portion of the credit line which is normally underutilized if the consumer 80 merely spends at merchants. Moreover, the consumer 80 can potentially achieve positive returns on the investments (ROI) and earn profits even without utilizing liquid assets. For the issuer financial institution 30, there is increased utilization of the credit line of the consumer 80. Collectively, increased utilization of multiple credit lines of multiple consumers 80 can potentially lead to higher revenues, particularly from interest charges and fees on the credit spending.

### DESCRIPTION OF EMBODIMENTS

In various embodiments of the present disclosure, the electronic system 10 includes the intermediary financial entity 20 operating the server 100, one or more issuer financial institutions 30 operating one or more issuer servers, and one or more acquirer financial institutions 40 operating one or more acquirer servers. The server 100 includes a processor, a data storage device or memory configured to store computer-readable instructions for processing thereby, and a data communication component/module 100a for communicating with one or more other data communication components and/or servers. It will be appreciated that an issuer financial institution 30 issues credit payment instruments 90, e.g., credit cards, to the consumers 80 who are customers of the issuer financial institution 30. Each credit payment instrument 90 is associated with a payment network operator. The intermediary financial entity 20 may be operated by or on behalf of the payment network 50. The intermediary financial entity 20 may also be a separate entity providing a third-party service to the payment network 50.

The credit payment instrument 90 may refer to any suitable cashless payment mechanism, such as payment cards and credit cards, which the consumer 80 may use to pay for transactions on a credit basis. The credit payment instrument 90 has a credit line associated therewith that is availed to the consumer 80 by the issuer financial institution 30 of the credit payment instrument 90. The credit line enables the consumer 80 to borrow money in advance for payment of transactions, e.g., to pay a merchant for goods and services, and is based on the consumer's promise to the issuer financial institution 30 to later settle the paid amounts (plus the other agreed charges/fees). In addition, details of the credit payment instrument 90 be stored electronically, such as on an electronic device of the consumer 80. For example, one or more credit payment instruments 90 may be linked to a digital wallet such that payments are made from one of the linked credit payment instruments 90. The consumer electronic device may be a mobile device, such as mobile phone, smartphone, personal digital assistant (PDA), tablet, laptop, or computer.

In many embodiments, the server 100 hosts a software application or website (collectively referred to as “application”) to perform the method 200. The application may alternatively be hosted on a separate cloud computing system communicatively linked to the server 100. The application provides a user interface accessible by the consumers 80 who intend to invest in the financial investment products. To facilitate said investments, participating issuer financial institutions 30 and financial investment institutions 60 are required to enroll via the application.

Various financial investment institutions 60 offer various types of financial investment products. Some financial investment institutions 60 include, but are not limited to, financial technology (fintech) companies such as Fisdom, FundsIndia, Betterment, Robinhood Markets, Zebpay, as well as other cryptocurrency investment companies. Some financial investment products offered by the financial investment institutions 60 include, but are not limited to, fixed deposits, debentures, and mutual funds (e.g., small cap funds, sector-based funds, large cap funds, and balanced funds). The financial investment products may be categorized by their investment risk, e.g., high-risk products, medium-risk products, and low-risk products. Investment risk can be defined as the likelihood of losses relative to the expected ROI. Generally, higher risk products have higher ROIs and lower risk products have lower ROIs. Low-risk financial investment products include liquid funds and short-term debts. Medium-risk financial investment products include long-term debts and equity-index funds. High-risk financial investment products include equity-sector focused funds, individual stocks, and cryptocurrencies. Fund managers in the financial investment institutions 60 may select and combine various financial investment products to form particular groups with particular investment risk levels.

A financial investment institution 60 who intends to offer one or more of their financial investment products to consumers 80 to invest in have to enroll or register with the intermediary financial entity 20 via the application. In the enrolment, the financial investment institution 60 forms an agreement with the intermediary financial entity 20 to offer financial investment products for consumers 80 to invest via the intermediary financial entity 20. This agreement may include an identifier and/or name of the financial investment institution 60, as well as various parameters and clauses, such as legal-related clauses. In addition, the financial investment institution 60 provides the investment risk categories of the financial investment products of financial investment products), e.g., low-risk, medium-risk, and high-risk. The financial investment institution 60 further provides details of the financial investment products, such as minimum/maximum ROI or gain, minimum/maximum tenure period, and loss/risk sharing allocation with the consumers 80. The details of the financial investment products may be categorized by their investment risk, e.g., high-risk products, medium-risk products, and low-risk products. However, if the financial investment institution 60 is unable to provide an estimated ROI or gain, then the financial investment institution 60 may provide details on liability on the consumers 80, such as a percentage of the credit line used for the investments.

Information provided by the financial investment institution 60 during enrolment may be stored on the financial investment database 70B. The financial investment database 70B may reside locally on the server 100, or alternatively on a remote server or computer communicatively linked to the server 100.

For a consumer 80 to be able to use a credit payment instrument 90 to invest in the financial investment products offered by the financial investment institution 60, the issuer financial institutions 30 associated with the credit payment instrument 90 has to enroll or register with the intermediary financial entity 20 via the application. In the enrolment, the issuer financial institution 30 forms an agreement with the intermediary financial entity 20 to facilitate transfer of funds from the credit payment instrument 90 of the consumer 80 to the financial investment institution 60 via the payment network 50. This agreement may include an identifier and/or name of the issuer financial institution 30, as well as various parameters and clauses, such as legal-related clauses. The issuer financial institution 30 may select which consumers 80, and optionally which credit payment instruments 90 of each consumer 80, to be eligible for credit-based investments. The issuer financial institution 30 may optionally provide details on the credit lines of each consumer 80. Thus, only the selected consumers 80, and optionally with the selected credit payment instruments 90, may enroll for investing in the financial investment products using the respective credit lines. Consumers 80 may be selected based on the credit lines availed to them, i.e., based on their credit rating/score. The selection of eligible consumers 80, and optionally the credit payment instruments 90, may be updated periodically with the intermediary financial entity 20. This may be done via daily batch updates alongside standard transaction messages between the issuer financial institution 30 and the intermediary financial entity 20. Alternatively, the issuer financial institution 30 may provide a monthly update on eligible consumers 80 to the intermediary financial entity 20.

The issuer financial institution 30 may also provide a blacklist and/or opt-out list containing details of consumers 80 that are not eligible for credit-based investments. The blackout list contains details of consumers 80 deemed ineligible by the issuer financial institution 30, such as due to consumer behavior, poor credit ratings, and failure to timely settle used credit lines. The opt-out list contains details of consumers 80 who have voluntarily opted out from credit-based investments.

Although a consumer 80 may hold one or more credit payment instruments 90, the credit line associated with each credit payment instrument 90 is a collective one. In other words, the issuer financial institution 30 avails to the consumer 80 a single credit line (capped at a predefined credit limit) regardless of the number of credit payment instruments 90. For each consumer 80, the issuer financial institution 30 may define percentage range of the credit line which can be used for investments. For example, the percentage range may include a capped or maximum percentage permissible for the consumer 80 to use for investments, as well as a floor or minimum percentage of the credit line for the consumer 80 to use for investments if the consumer 80 decides to proceed with the investments.

In the enrollment, the issuer financial institution 30 views the various financial investment products offered by the various financial investment institutions 60 enrolled with the intermediary financial entity 20. The issuer financial institution 30 may select and predetermine one or more financial investment products with one or more financial investment institutions 60. The predetermination of financial investment products between the issuer financial institution 30 and financial investment institutions 60 may be based on various factors, such as trustworthiness of the financial investment institutions 60 and benefits of the financial investment products to both issuer financial institution 30 and consumers 80. Upon said predetermination, the intermediary financial entity 20 forms bipartite contracts between the issuer financial institution 30 and each financial investment institution 60. Each bipartite contract is identifiable by a unique contract identifier. Each bipartite contract may be perpetually effective until terminated by either party, or may start and end on dates predetermined by both parties.

The issuer financial institution 30 further provides additional details during enrollment, such as fee structures for the financial investment institutions 60 and consumers 80. The fee structures for the financial investment institutions 60 relate to the issuer financial institution 30 earning commissions from the financial investment institutions 60 based on the amount of money invested by the consumers 80. The fee structures for the consumers 80 relate to charging premiums, e.g., monthly fees, to the consumers 80 for allowing them to use their credit line for credit-based investments.

Information provided by the issuer financial institution 30 during enrollment may be stored on the issuer database 70A. The issuer database 70A may reside locally on the server 100, or alternatively on a remote server or computer communicatively linked to the server 100.

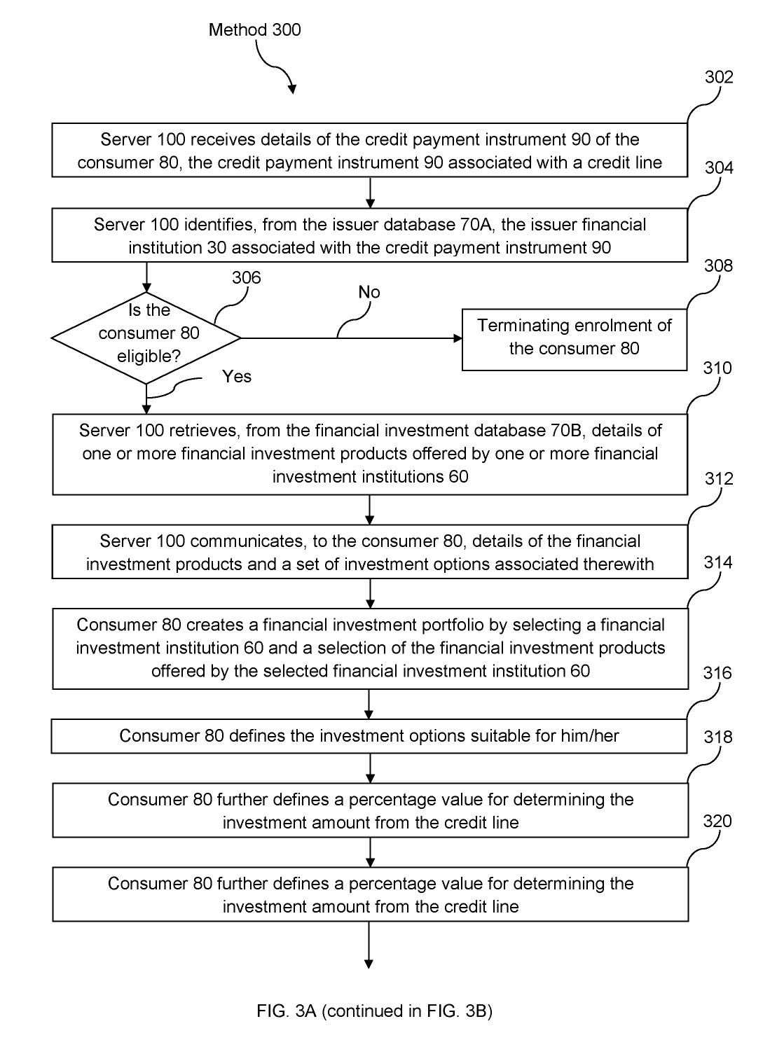

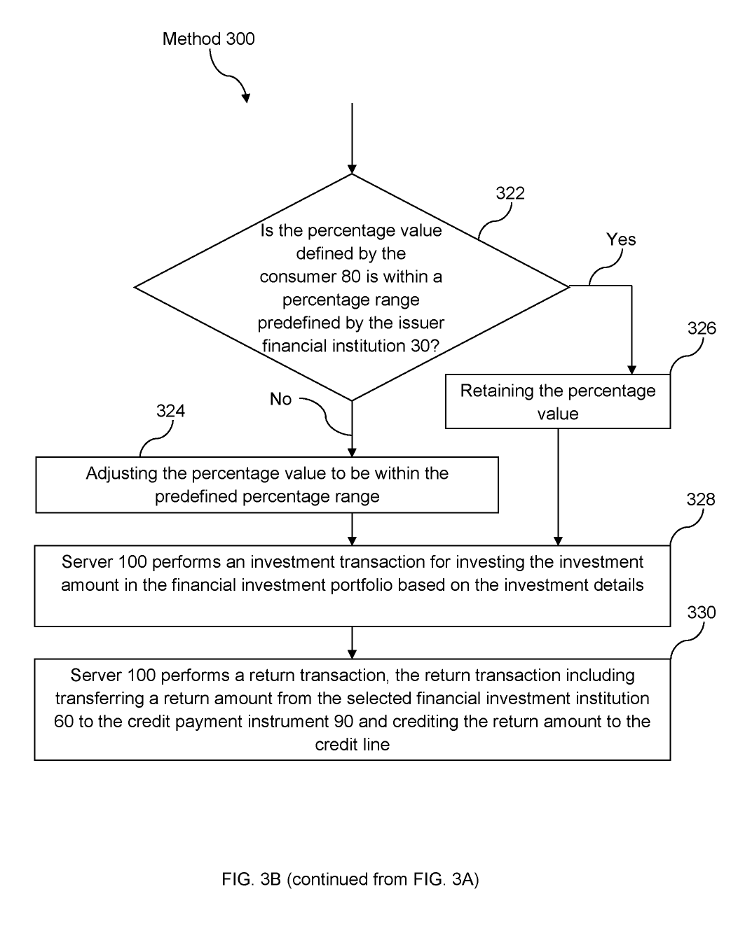

For a consumer 80 to participate in credit-based investments, the consumer 80 has to enroll or register with the intermediary financial entity 20 via the application. This may be done via the user interface provided by the application and presented on a consumer electronic device communicable with the server 100. The consumer electronic device may be a mobile device, such as mobile phone, smartphone, personal digital assistant (PDA), tablet, laptop, or computer. In some embodiments, various steps of the enrolment of the consumer 80 is described as a computer-implemented or computerized method 300 implemented on the server 100, with reference to FIG. 3A and FIG. 3B.

During the enrollment, the consumer 80 inputs details of a credit payment instrument 90, e.g., credit card number, with the consumer electronic device. The consumer 80 may input additional personal details such as name and identification number. In a step 302 of the method 300, the data communication component/module 100a of the server 100 receives details of the credit payment instrument 90 of the consumer 80, the credit payment instrument 90 associated with a credit line. In a step 304, an identification component/module 100b of the server 100 identifies, from the issuer database 70A, the issuer financial institution 30 associated with the credit payment instrument 90. In one embodiment, the consumer 80 is automatically eligible for credit-based investments if the issuer financial institution 30 of the credit payment instrument 90 is already enrolled, i.e., is identifiable from the issuer database 70A. In another embodiment, there is a step 306 wherein the identification component 100b of the server 100 identifies, from the issuer database 70A, whether the consumer 80 is eligible based on details of the credit payment instrument 90 (to identify the consumer 80) as well as details provided by the issuer financial institution 30 during enrollment.

If the consumer 80 is ineligible, the step 306 proceeds to a step 308 of terminating enrolment of the consumer 80. Conversely, if the consumer 80 is eligible, the step 308 proceeds to a step 310 wherein a data retrieval component/module 100c of the server 100 retrieves, from the financial investment database 70B, details of one or more financial investment products offered by one or more financial investment institutions 60. As described above, the financial investment products have been predetermined between the issuer financial institution 30 and financial investment institutions 60.

In a step 312, the server 100 communicates, to the consumer 80, details of the financial investment products and a set of investment options associated therewith. Specifically, the data communication component 100a of the server 100 communicates the details and investment options to the consumer electronic device. The consumer 80 may review the respective bipartite contracts, available financial investment products, and investment options on the consumer electronic device, and decide on the appropriate financial investment products and investment options for himself/herself. Specifically, in a step 314, the consumer 80 creates a financial investment portfolio by selecting a financial investment institution 60 based on the bipartite contracts, together with a selection of the financial investment products offered by the selected financial investment institution 60. The consumer 80 may select the financial investment products based on various factors, such as their expected ROIs.

In a step 316, the consumer 80 defines the investment options suitable for him/her. In some embodiments, the investment options include risk options relating to investment risks of the financial investment products, allowing the consumer 80 to select preferred financial investment products into the financial investment portfolio based on his/her risk appetite. For example, if the consumer 80 is a risk-taker, he/she may select high-risk financial investment products such as cryptocurrencies. In some embodiments, the investment options include tenure options for determining a tenure period for investing an investment amount in the selected financial investment products. The tenure options may include a start date and/or end date of the investment. In some embodiments, the investment options include tranche options relating to investing the investment amount as a single tranche upon start of the tenure period or as multiple tranches or installments during the tenure period. For example, in a single tranche, a single payment of the investment amount is transferred from the credit payment instrument 90 to the financial investment institution 60 on the start date of the tenure period. In an example for multiple tranches, the investment amount is divided into distinct payments on different dates during the tenure period.

In a step 318, the consumer 80 further defines a percentage value for determining the investment amount from the credit line. For example, if the consumer 80 has a credit line of $10,000 and defines a percentage value of 20%, the investment amount would be $2,000.

Accordingly, in the steps 314, 316, and 318, the consumer 80 creates investment details relevant to his/her investing in the financial investment portfolio. Specifically, the investment details include the financial investment portfolio, and the consumer-defined investment options and percentage value. In a step 320, the data communication component 100a of the server 100 receives the investment details from the consumer 80, specifically from the consumer electronic device.

The investment details provided by the consumer 80 during enrolment may be stored on the consumer database 70C. An investment details collator component/module 100d collates or aggregates the investment details and stores them on the consumer database 70C. The consumer database 70C may reside locally on the server 100, or alternatively on a remote server or computer communicatively linked to the server 100. Upon successful enrolment, an enrolment message is communicated to the consumer 80, e.g., displayed on the consumer electronic device.

After the consumer 80 determines and communicates the investment details, which are determined based on the respective bipartite contract between the issuer financial institution 30 and respective financial investment institution 60, a tripartite contract is formed among the consumer 80, issuer financial institution 30, and financial investment institution 60. The tripartite contract is identifiable by a unique contract identifier, allowing the consumer 80 to easily identify and access the progress of his/her investment by retrieving updated data from the consumer database 70C.

In a step 322, a verification component/module 100e of the server 100 verifies whether the percentage value defined by the consumer 80 is within a percentage range predefined by the issuer financial institution 30. The predefined percentage range includes a capped/maximum percentage and a floor/minimum percentage. If the percentage value falls outside the predefined percentage range, the step 322 proceeds to a step 324 of adjusting the percentage value to be within the predefined percentage range. In one example, if the predefined percentage range is 0% to 15% and the percentage value is 20%, the percentage value is adjusted to 15%. In another example, if the predefined percentage range is 5% to 15% and the percentage value is 2%, the percentage value is adjusted to 5%. A notification may be communicated to the consumer 80 to request for confirmation of any adjustment of the percentage value. Conversely, if the percentage value is already within the predefined percentage range, the step 322 proceeds to a step 326 of retaining the percentage value.

In a step 328, a transaction processor component/module 100f of the server 100 performs an investment transaction for investing the investment amount in the financial investment portfolio based on the investment details. Specifically, the investment is based on the investment details determined by the consumer 80 and collated by the investment details collator component 100d, the investment details including his/her preferred risk options and tenure options. In some embodiments, the consumer 80 defines the tenure period to start on a future start date. Thus, the investment transaction would only be performed when the tenure period starts on the future start date.

The investment transaction may be performed in a standard manner as a typical payment transaction, as would be readily known to the skilled person. Particularly, the investment transaction includes debiting the investment amount from the credit line and transferring the investment amount from the credit payment instrument 90 to the selected financial investment institution 60. In one embodiment, the server 100 does not have details of the credit line of the consumer 80. The server 100 communicates, via the payment network 50, the percentage value to the issuer financial institution 30. The issuer financial institution 30 determines the investment amount based on the percentage value and credit line, and proceeds to authorization of debiting the investment amount from the credit line. In another embodiment, the server 100 has details of the credit line and determines the investment amount. The investment amount is communicated to issuer financial institution 30 for authorization of debiting from the credit line. Authorization of said debiting is then communicated to the server 100 via the payment network 50. It will be appreciated that said debiting may occur at multiple instances if the investment amount is to be paid in multiple tranches or installments.

After receiving the authorization, the server 100 transfers, via the payment network 50, the investment amount to the acquirer financial institution 40 with which the selected financial investment institution 60 has a financial account. The financial account of the selected financial investment institution 60 is then credited with the investment amount by the acquirer financial institution 40.

In some embodiments, the transaction processor component 100f of the server 100 performs a commission transaction in response to completion of the investment transaction. The commission transaction includes transferring a commission amount from the selected financial investment institution 60 to the issuer financial institution 30. For example, the bipartite contract between the issuer financial institution 30 and selected financial investment institution 60 may include a fee structure relating to the issuer financial institution 30 earning commissions from the selected financial investment institution 60 based on the investment amount. Thus, upon completion of the investment transaction, the commission amount is paid from the financial account of the selected financial investment institution 60 held at the acquirer financial institution 40 to the issuer financial institution 30. It will be appreciated that the commission transaction may be performed in a standard manner as a typical payment transaction, as would be readily known to the skilled person.

During the tenure period of the investment, the consumer 80 may access the application to check on the progress or health of the financial investment portfolio. The selected financial investment institution 60 would update the value of the financial investment portfolio periodically or in real-time, so that the consumer 80 can retrieve timely updates. Furthermore, the consumer 80 may terminate the investment at any time during the tenure period, such as to cut losses if the investment is in a downward trend. The consumer 80 may also choose to withdraw part of the value of the financial investment portfolio. However, early termination/withdrawal may risk losing part or all of the investment amount.

At the end of the tenure period of the investment, in a step 330, the transaction processor component 100f of the server 100 performs a return transaction, i.e., on the end date of the tenure period. The return transaction includes transferring a return amount from the selected financial investment institution 60 to the credit payment instrument 90 and crediting the return amount to the credit line. It will be appreciated that the return transaction may be performed in a standard manner as a typical payment transaction, as would be readily known to the skilled person. Particularly, the return amount is debited from the financial account of the selected financial investment institution 60 held at the acquirer financial institution 40. The return amount is then transferred, via the payment network 50, from the acquirer financial institution 40 to the issuer financial institution 30. The credit line of the consumer 80 is then credited with the return amount, thereby reducing a used portion of the credit line.

In one embodiment, the return amount includes the investment amount and an investment gain, i.e., there is an investment profit on the principal investment amount or positive ROI. The investment gain may be used for offsetting a used portion of the credit line. For example, if part of the credit line is used for expenses other than the investment amount, the investment gain may be used to offset such expenses. In another embodiment, the return amount is less than the investment amount, i.e., there is an investment loss from the principal investment amount or negative ROI. The used portion of the credit line may increase as the consumer 80 may expected to be liable for the investment loss.

In some embodiments, the selected financial investment institution 60 may have a loss/risk sharing allocation with the consumer 80. The consumer 80 may be liable for part of the investment loss, or may not be liable at all, i.e., the investment loss is entirely borne by the selected financial investment institution 60.

In some embodiments, there is a fee structure relating to the issuer financial institution 30 charging a premium or fee to the consumer 80 for allowing the consumer 80 to use the credit line for the investments. The premium may be a predefined percentage of the investment amount, such as 0.1%. The premium may be paid to the issuer financial institution 30 with the credit payment instrument 90, i.e., by debiting the credit line in addition to the investment amount. In one embodiment, the premium is a fixed fee regardless of the investment risk of the financial investment portfolio. In another embodiment, the premium is associated with the investment risk. For example, a high-risk portfolio may incur lower premiums to attract more consumers 80 to invest in such.

An advantage of the investments is that the consumer 80 can use the credit line to invest in a selected financial investment portfolio, i.e., credit-based investments. The consumer 80 does not need to utilize his/her liquid assets, e.g., cash, for investments, thereby freeing up the liquid assets for other purposes. This may be attractive to the consumer 80 especially if he/she knows that there is no major expenditure in the near future. Even if there is, the consumer 80 may choose a small percentage value for the investment amount.

Another advantage is that the consumer 80 can potentially earn an investment gain/profit or positive ROI even without utilizing liquid assets. The investment gain/profit can be used to offset the used portion of the credit line. In other words, the investment gain/profit funds the credit line of the consumer 80, similar to cash rebates earned from usage of credit cards.

By blocking the investment amount from the credit line to invest in the financial investment portfolio, the consumer 80 utilizes a larger portion of the credit line which is normally underutilized if the consumer 80 merely uses the credit payment instrument 90 for expenses at merchants. Increased usage of the credit line may improve the chances of the consumer 80 getting an offer from the issuer financial institution 30 to increase the credit limit. For the issuer financial institution 30, there is increased utilization of the credit line of the consumer 80. Collectively, increased utilization of multiple credit lines of multiple consumers 80 can potentially lead to higher revenues, particularly from interest charges and fees on the used portion of the credit line, i.e., credit spending. The issuer financial institution 30 may also earn revenue in the form of commissions charged to the financial investment institutions 60 and premiums charged to the consumers 80.

Credit payment instruments 90 which are issued by an issuer financial institution 30 and which are selected to be eligible for credit-based investments may become more popular with consumers 80 who are interested in the credit-based investments. This would lead to increased revenue for the issuer financial institution 30 as more consumers 80 would become their customers by signing up for these credit payment instruments 90.

For the financial investment institutions 60, they are able to get additional funds to invest in their financial investment products. The financial investment institutions 60 may offer more conservative expected ROIs on their financial investment products so as to ensure they make at least some profits. Furthermore, the financial investment institutions 60 may have loss/risk sharing allocations with the consumers 80 to transfer the risk of losses (or part thereof) to the consumers 80.

As disclosed in various embodiments herein, the system 10, method 200, and method 300 provide for credit-based investments using the credit line associated with a credit payment instrument 90 of a consumer 80. The consumer 80 can invest in a financial investment portfolio including a selection of financial investment products offered by a selected financial investment institution 60 which is trusted by the issuer financial institution 30. Furthermore, the consumer 80 can assess the investment risks and expected ROIs, and make informed decisions when selecting an appropriate financial investment portfolio for investing.

### Technical Architecture

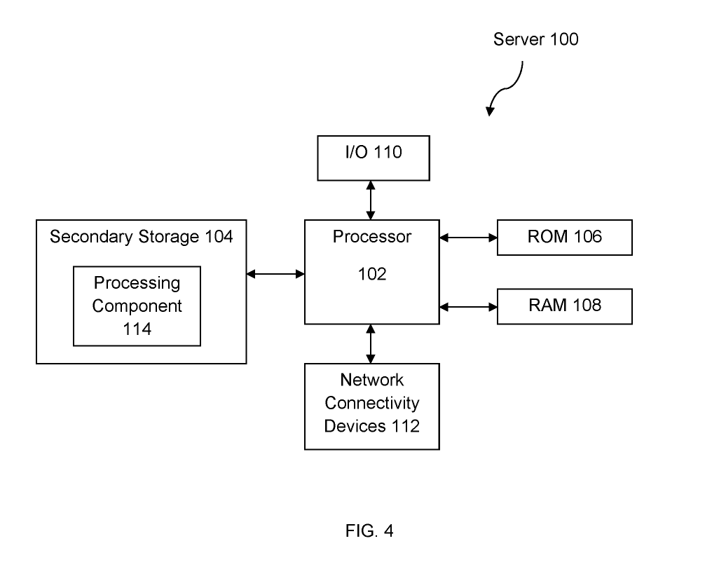

The following is a description of the technical architecture of the server 100 with reference to FIG. 4.

The technical architecture of the server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 200/300 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 200/300 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 200/300. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic system and method for credit-based investments are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic system for credit-based investments, the system comprising a server configured to:
receive details of a credit payment instrument associated with a consumer, the credit payment instrument further associated with a credit line;
identify, from an issuer database, an issuer financial institution associated with the credit payment instrument;
retrieve, from a financial investment database, details of one or more financial investment products offered by one or more financial investment institutions, the financial investment products predetermined between the issuer financial institution and the one or more financial investment institutions;
communicate, to the consumer, details of the financial investment products and a set of investment options associated therewith;
receive investment details determined by the consumer, the investment details comprising:
a financial investment portfolio comprising a selection of the financial investment products offered by a financial investment institution selected by the consumer;
the investment options defined by the consumer; and
a percentage value defined by the consumer for determining an investment amount from the credit line; and
perform an investment transaction for investing the investment amount in the financial investment portfolio based on the investment details.

2. The system according to claim 1, wherein the server is further configured to adjust the percentage value to be within a percentage range predefined by the issuer financial institution if the percentage value falls outside the predefined percentage range.

3. The system according to claim 1, wherein the server is configured, in connection with performing the investment transaction, to debit the investment amount from the credit line and transfer the investment amount from the credit payment instrument to the selected financial investment institution.

4. The system according to claim 1, wherein the investment options comprise tenure options for determining a tenure period for investing the investment amount.

5. The system according to claim 4, wherein the investment transaction is performed when the tenure period starts.

6. The system according to claim 4, wherein the server is further configured to perform a return transaction when the tenure period ends.

7. The system according to claim 6, wherein the server is configured, in connection with performing the return transaction, to transfer a return amount from the selected financial investment institution to the credit payment instrument and credit the return amount to the credit line.

8. The system according to claim 7, wherein the return amount comprises the investment amount and investment gains, the investment gains for offsetting a used portion of the credit line.

9. The system according to claim 4, wherein the investment options comprise tranche options relating to investing the investment amount as a single tranche upon start of the tenure period or as multiple tranches during the tenure period.

10. The system according to claim 1, wherein the investment options comprise risk options relating to investment risks of the financial investment portfolio.

11. The system according to claim 1, wherein the server is further configured to perform a commission transaction in response to completion of the investment transaction, to transfer a commission amount from the selected financial investment institution to the issuer financial institution.

12. A computerized method for credit-based investments, the method comprising:
receiving, by a server of an electronic system, details of a credit payment instrument of a consumer, the credit payment instrument associated with a credit line;
identifying, by the server, from an issuer database, an issuer financial institution associated with the credit payment instrument;
retrieving, by the server, from a financial investment database, details of one or more financial investment products offered by one or more financial investment institutions, the financial investment products predetermined between the issuer financial institution and the one or more financial investment institutions;
communicating, by the server, to the consumer, details of the financial investment products and a set of investment options associated therewith;
receiving, by the server, investment details determined by the consumer, the investment details comprising:
a financial investment portfolio comprising a selection of the financial investment products offered by a financial investment institution selected by the consumer;
the investment options defined by the consumer; and
a percentage value defined by the consumer for determining an investment amount from the credit line; and
performing, by the server, an investment transaction for investing the investment amount in the financial investment portfolio based on the investment details.

13. The method according to claim 12, further comprising adjusting the percentage value to be within a percentage range predefined by the issuer financial institution if the percentage value falls outside the predefined percentage range.

14. The method according to claim 12, wherein performing the investment transaction includes comprising debiting the investment amount from the credit line and transferring the investment amount from the credit payment instrument to the selected financial investment institution.

15. The method according to claim 12, wherein the investment options comprise tenure options for determining a tenure period for investing the investment amount.

16. The method according to claim 15, further comprising performing a return transaction when the tenure period ends.

17. The method according to claim 16, wherein performing the return transaction includes transferring a return amount from the selected financial investment institutions to the credit payment instrument and crediting the return amount to the credit line.

18. The method according to claim 12, further comprising performing a commission transaction in response to completion of the investment transaction, the commission transaction for transferring a commission amount from the selected financial investment institutions to the issuer financial institution.

19. A non-transitory computer-readable storage medium storing computer-readable instructions that, when executed, cause a server to:
receive details of a credit payment instrument of a consumer, the credit payment instrument associated with a credit line;
identify, from an issuer database, an issuer financial institution associated with the credit payment instrument;
retrieve, from a financial investment database, details of one or more financial investment products offered by one or more financial investment institutions, the financial investment products predetermined between the issuer financial institution and the one or more financial investment institutions;
communicate, to the consumer, details of the financial investment products and a set of investment options associated therewith;
receive investment details determined by the consumer, the investment details comprising:
a financial investment portfolio comprising a selection of the financial investment products offered by a financial investment institution selected by the consumer;
the investment options defined by the consumer; and
a percentage value defined by the consumer for determining an investment amount from the credit line; and
perform an investment transaction for investing the investment amount in the financial investment portfolio based on the investment details.
